(19) United States
(12) Patent Application Publication
(10) Pub. No.: US 2003/0011535 A1
(43) Pub. Date: Jan. 16, 2003

(54) Image display device, image displaying method, information storage medium, and image display program

(76) Inventors: Tohru Kikuchi, Tokyo (JP); Minoru Nagahori, Tokyo (JP)

Correspondence Address: DELLETT AND WALTERS, 310 S.W. FOURTH AVENUE, SUITE 1101, PORTLAND, OR, 97204, US

(21) Appl. No.: 10/164,351

(22) Filed: Jun. 5, 2002

(30) Foreign Application Priority Data
Jun. 27, 2001 (JP) 2001-194874
Apr. 19, 2002 (JP) 2002-117428

(51) Int. Cl. G09G 5/00

(52) U.S. Cl. 345/6

(57) ABSTRACT

A perspective projection conversion is performed on a 3-dimensional object onto a plurality of virtual planes. After image information corresponding to each plane is stored in a flat buffer, the image information is read from the flat buffer for each of a plurality of sectioned areas forming each of a plurality of planes, and stored in a corresponding area in a frame buffer, and the image corresponding to the image information stored in the frame buffer is projected onto a curved surface screen through a wide-angle lens, thus disclosing the image display device.

### BACKGROUND OF THE INVENTION

The present invention relates to an image display device, an image displaying method, an information storage medium, and an image display program for projecting an image on a curved surface screen through a wide-angle lens.

An image display device for projecting an image on a nonflat screen has conventionally been used. For example, Japanese Patent Laid-open No. 9-81785 and 3-82493 disclose various image display devices for projecting an image onto a nonflat screen and correcting the distortion of the projected image. If an image generated for projection onto a flat screen is projected onto a nonflat screen as is, the image is displayed as a distorted image. Therefore, the above mentioned image display devices consider the distortion of the image when it is displayed as is, and correct the distortion of an image on the nonflat screen by generating an image distorted in the direction opposite to the distortion in advance such that the distorted image can finally be displayed correctly.

According to the above mentioned conventional image display devices, if an image is distorted into a convex image, a distorted image in a concave shape is generated in advance, thereby correcting the distortion on the nonflat screen. However, with these apparatuses, when a 3-dimensional object arranged in a 3-dimensional space is displayed on a nonflat screen, the resultant distortion cannot be successfully corrected. For example, when the projection position and the eyepoint location of an image are different, the extent of the distortion of a generated image depends on the distance from a 3-dimensional object. Therefore, only simple distortion on a generated image cannot successfully remove the distortion from a projected image. Especially, it is considered that there is an essential difference between the distortion correction of a 2-dimensional image and the distortion correction of a 3-dimensional image. With the image display devices disclosed in the above mentioned laid-open patent applications, only the methods of correcting the distortion of a 2-dimensional image are disclosed. Therefore, with these methods, the distortion of an image obtained by projecting a 3-dimensional object on a screen cannot be satisfactorily removed.

### SUMMARY OF THE INVENTION

The present invention has been achieved to solve the above mentioned problems with the conventional technology, and aims at providing an image display device, an image displaying method, an information storage medium, and an image display program for projecting an image with little distortion onto a curved surface screen.

The image display device according to the present invention includes a frame buffer, a projection device, plane processing unit, and image information transferring unit to project an image of a 3-dimensional object arranged in a virtual 3-dimensional space onto a curved surface screen through a wide-angle lens. In the frame buffer, the position in which an image is to be projected onto a curved surface screen corresponds to the storage position of image information. The projection device emits an image corresponding to the image information stored in the frame buffer to a wide-angle lens. The plane processing unit performs a perspective projection conversion on a 3-dimensional object onto a plurality of virtual planes, and stores the image information corresponding to each plane in a flat buffer. The image information transferring unit reads the image information from the flat buffer for each of a plurality of sectioned areas forming the plurality of virtual planes, and stores it in the corresponding area of the frame buffer. After the plane processing unit performs a perspective projection conversion on a 3-dimensional object onto a plurality of virtual planes and stores the image information in the flat buffer, the image information transferring unit transfers the image information to the frame buffer for each sectioned area. Since the distortion is corrected after the image information is stored in the frame buffer such that the distortion can be removed with the fixed positional relationship between a virtual plane and a curved surface screen taken into account, an image can be projected with little distortion onto the curved surface screen. When a linearly interpolating process is performed on an internal area specified by a vertex of a sectioned area, the function of hardware performing a texture mapping process can be used, thereby shortening the processing time (transfer time) and reducing the entire cost, etc. By performing the linear interpolation, there arises an error in the position of the destination, which can be satisfactorily reduced to a tolerable extent by setting a sufficiently small sectioned area.

It is desirable that the above mentioned wide-angle lens is a fisheye lens. Using a fisheye lens, a projection angle of about 180° can be realized. As a result, the projected image is displayed on the curved surface screen, thereby projecting a realistic image with little distortion.

Furthermore, It is also desirable that the above mentioned sectioned area is polygonal, and is desirable to provide corresponding coordinate setting unit for associating the first storage coordinate of the flat buffer with the second storage coordinate of the frame buffer for each vertex of the polygon, and to allow the above mentioned image information transferring unit to read the image information about the sectioned areas specified by a plurality of first storage coordinates from the flat buffer, and store the image information in a predetermined area of the frame buffer specified by a plurality of second storage coordinates corresponding to the respective first storage coordinates. When a linearly interpolating process is performed on an internal area of the polygon specified by the vertex of a sectioned area, the functions of the hardware performing a texture mapping process can be used, thereby successfully shortening the processing time.

Furthermore, It is desirable to allow the above mentioned corresponding coordinate setting unit to hold the correspondence information indicating the correspondence between the first storage coordinate and the second storage coordinate, and read and store the image information by the image information transferring unit according to the correspondence information. After obtaining and holding the correspondence information by computation, etc., the computation for the correspondence information is not required, thereby further reducing the load of the subsequent processes.

Additionally, It is desirable that the number of the above mentioned plural virtual planes is 5. Thus, when a virtual 3-dimensional space is viewed from a predetermined eyepoint location, the area all around ahead of the eyepoint can be covered by these planes. Therefore, the image information corresponding to a 3-dimensional object in the view direction can be stored in the frame buffer with reliability.

In addition, it is desirable that the number of a plurality of virtual planes is 3 or 4. By appropriately setting the shape and arrangement of these planes, it is possible to completely cover the periphery of the predetermined eyepoint location in the virtual 3-dimensional space with the above mentioned planes, and the image information corresponding to the 3-dimensional object in the view direction can be certainly stored in the frame buffer although the number of a plurality of virtual planes is smaller than 5, that is, although it is 3 or 4. Particularly, by setting the number of the plurality of virtual planes to a value smaller than 5, the number of planes to be processed in the perspective projection conversion process can be reduced, thereby successfully shortening the processing time required to perform the process.

Furthermore, the number of the above mentioned plurality of virtual planes can be set to 2. When there is a section hardly entering the view in the curved surface screen, when there is a portion where an image is not to be projected onto a potion of the curved surface screen for any reason (for example, when a part of the curved surface screen is cut off to reserve a foot space in which a viewer of an image projected onto the curved surface screen), etc., the image information corresponding to the portion to be practically projected can be processed although the number of the plurality of virtual planes is 2. Particularly, by setting the number of the plurality of virtual planes to 2, the number of planes to be processed in the perspective projection conversion by the plane processing unit can be furthermore reduced, thereby considerably reducing the processing time required in the perspective projection conversion.

It is also desirable that a predetermined eyepoint location is different from a projection position corresponding to a wide-angle lens. Practically, an image displayed on the curved surface screen cannot be seen from the projection position. Therefore, an image can be projected with little distortion on a practical condition by correcting the distortion based on the assumption that the eyepoint location is different from the projection position.

When the projection position is set to be different from the central position of the curved surface screen, It is desirable that the above mentioned image information transferring unit amends the brightness for the image information to be stored in the frame buffer with the distance between the projection position and the position in which an image is projected on the curved surface screen taken into account. If the projection position is different from the central position, then there occurs uneven brightness in a projected image although an image having even brightness is projected. Therefore, by adjusting the brightness with the distance taken into account, an image can be obtained with substantially even brightness, that is, without uneven brightness.

Additionally, It is desirable to further include object computation unit for computing the positional information about the virtual 3-dimensional space of a 3-dimensional object at predetermined time intervals, and to repeat the process of storing the image information for the frame buffer at predetermined time intervals. When a 3-dimensional object stirs, or when the 3-dimensional object moves in a virtual 3-dimensional space, the coordinates of the 3-dimensional object are computed at predetermined time intervals and a distortion-free image is generated each time the computation is performed. Therefore, in a game, presentation, etc. using a 3-dimensional object, a distortion-free moving picture can be projected onto the curved surface screen.

The image displaying method according to the present invention includes: a first step of performing a perspective projection conversion on a 3-dimensional object onto a plurality of virtual planes, and storing the image information corresponding to each plane in the flat buffer; a second step of reading the image information from the flat buffer for each of the plurality of sectioned areas forming the respective plural virtual planes, and storing the information in the corresponding area in the frame buffer; and a third step of reading the image information stored in the frame buffer and projecting the information onto the curved surface screen through a wide-angle lens.

The information storage medium according to the present invention includes a program for executing the above mentioned first to third steps.

The image display program according to the present invention is used to direct a computer to perform the above mentioned first to third steps to project an image of a 3-dimensional object arranged in a virtual 3-dimensional space onto a curved surface screen through a wide-angle lens.

By using the image displaying method according to the present invention, or by executing the program stored in the information storage medium according to the present invention or the image display program according to the present invention, an image can be projected on the curved surface screen with little distortion.

It is also desirable that the above mentioned sectioned area is polygonal, and the first storage coordinate of the flat buffer is associated with the second storage coordinate of the frame buffer for each vertex of the polygon. In this case, it is desirable in the second step that the image information about the sectioned area specified by a plurality of first storage coordinates is read from the flat buffer, and the image information is stored in a predetermined area of the frame buffer specified by a plurality of second storage coordinates corresponding to the respective first storage coordinates. When a linear interpolation process is performed on an area in the polygon specified by the vertex of the sectioned area, the functions of the hardware performing a texture mapping process can be used, thereby successfully shortening the processing time.

Furthermore, It is also desirable that the first storage coordinate of the flat buffer is associated with the second storage coordinate of the frame buffer with the predetermined eyepoint location and the projection position corresponding to the position of the wide-angle lens taken into account. Since the association between the first storage coordinate of the flat buffer and the second storage coordinate of the frame buffer is set in consideration of both eyepoint location and projection position, and image can be projected with less distortion.

It is also desirable that, when the projection position is different from the central position of the curved surface screen, the process in step 4 of amending the brightness of the image information to be stored in the frame buffer with the distance between the projection position and the position in which an image is to be projected onto the curved surface screen taken into account precedes the process in step 3. By adjusting the brightness with the distance taken into account, the unevenness in brightness can be removed, and an image can be obtained without any uneven brightness.

### BRIEF DESCRIPTION OF THE DRAWINGS

FIG. 1 shows a configuration of a game system according to an embodiment of the present invention;

FIG. 2 shows a virtual plane used in a projecting process by a plane processing section;

FIG. 3 shows a practical example of a perspective projection conversion;

FIG. 4 shows a practical example of a perspective projection conversion;

FIG. 5 shows a practical example of a plurality of sectioned areas respectively corresponding to five virtual planes S1 through S5;

FIG. 6 shows a correspondence between image information stored in a flat buffer and a sectioned area forming each plane;

FIG. 7 shows a correspondence among the sectioned areas in a circular frame buffer;

FIG. 8 is a flowchart showing an outline of an operation procedure of a game system according to an embodiment of the present invention;

FIG. 9 shows a range of drawing a circular frame buffer;

FIG. 10 shows an outline of a coordinate converting process;

FIG. 11 shows an outline of a coordinate converting process performed when a projection position is changed from a sphere center position of a spherical screen;

FIG. 12 shows a positional relationship between the spherical screen and the planes S1 through S5 when an eyepoint deviates from the sphere center position of the spherical screen;

FIG. 13 shows an outline of the coordinate converting process when the eyepoint location and the projection position deviate from the sphere center position of the spherical screen;

FIG. 14 shows an example of a variation of amending brightness;

FIG. 15 shows a virtual plane when four planes are used in projecting an image of a 3-dimensional object;

FIG. 16 shows a practical example of a plurality of sectioned areas respectively corresponding to the four virtual planes S1 through S4;

FIG. 17 shows a correspondence between the image information stored in a flat buffer and the sectioned area forming each plane (four planes);

FIG. 18 shows a correspondence between the image information stored in a flat buffer and the sectioned areas in a circular frame buffer (four planes);

FIG. 19 shows a virtual plane when three planes are used in projecting an image of a 3-dimensional object;

FIG. 20 shows a practical example of a plurality of sectioned areas respectively corresponding to the three virtual planes S1 through S3;

FIG. 21 shows a correspondence between the image information stored in a flat buffer and the sectioned area forming each plane (three planes);

FIG. 22 shows a correspondence between the image information stored in a flat buffer and the sectioned areas in a circular frame buffer (three planes);

FIG. 23 shows a virtual plane in another case when three planes are used in projecting an image of a 3-dimensional object;

FIG. 24 shows another practical example of a plurality of sectioned areas respectively corresponding to the three virtual planes S1 through S3;

FIG. 25 shows another example of the correspondence between the image information stored in a flat buffer and the sectioned area forming each plane (three planes);

FIG. 26 shows another example of the correspondence between the image information stored in a flat buffer and the sectioned areas in a circular frame buffer (three planes); and

FIG. 27 shows a virtual plane when two planes are used in projecting an image of a 3-dimensional object.

### DESCRIPTION OF THE PREFERRED EMBODIMENT

A game system according to an embodiment of the present invention is described below by referring to the attached drawings.

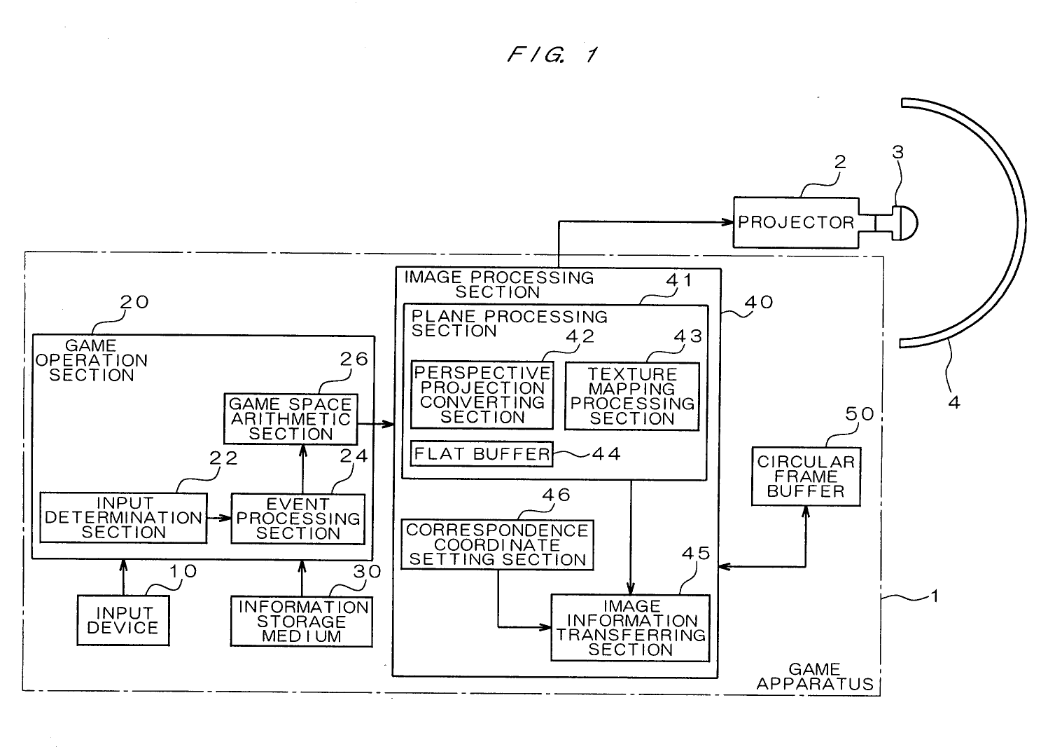

FIG. 1 shows a configuration of a game system according to the present embodiment. The game system shown in FIG. 1 comprises a game apparatus 1, a projector 2, a lens 3, and a spherical screen 4.

The game apparatus 1 performs various game arithmetic operations for the operation of a player, and generates image information for display of a game image depending on the progress of a game. The projector 2 emits a game image onto the spherical screen 4 according to the image information generated by the game apparatus 1. The lens 3 projects the game image emitted by the projector 2 onto the spherical screen 4. According to the present embodiment, a wide-angle lens is used as the lens 3. To be more practical, a fisheye lens having a projection angle of about 180° is used. The spherical screen 4 is a type of curved surface screen, has a hemispheric projection surface, and a game image emitted from the projector 2 through the lens 3 is projected onto the inside surface.

Described below in detail is a configuration of the game apparatus 1. The game apparatus 1 shown in FIG. 1 comprises an input device 10, a game operation section 20, an information storage medium 30, an image processing section 40, and a circular frame buffer 50.

The input device 10 is used by a player in inputting various instructions into the game apparatus 1, and is configured by various operation keys, operation levers, etc. to be used depending on the type of game performed using the game apparatus 1. For example, the input device 10 provided for performing a driving game comprises a handle, an accelerator, a brake, a transmission lever, etc.

The game operation section 20 performs predetermined game arithmetic operations required for the progress of the game. The game operation section 20 comprises an input determination section 22, an event processing section 24, and a game space arithmetic section 26. The game operation section 20 can be realized by executing a predetermined game program using a CPU, semiconductor memory such as ROM, RAM, etc.

The input determination section 22 determines the operation states of the handle, the accelerator, the brake, etc. provided for the input device 10, and outputs the signal corresponding to each operation state to the event processing section 24. The event processing section 24 performs the processes required for the progress of a game such as the occurrences of various events, branch determinations, etc., corresponding to the progress of the game. The game space arithmetic section 26 computes the positional information about various 3-dimensional objects existing in the game space that is a virtual 3-dimensional space. Each of the 3-dimensional objects according to the present embodiment is formed by a plurality of polygons, and the game space arithmetic section 26 computes the coordinates of the vertex of each polygon forming the 3-dimensional object.

The information storage medium 30 stores a program and data for operating the game apparatus 1 having the function of a computer. Practically, the information storage medium 30 stores a game program executed by the game operation section 20, necessary data required to display a game image (texture data for texture mapping, etc.), and an image display program. The information storage medium 30 is realized by CD-ROM, DVD-ROM, a hard disk device, semiconductor memory, etc.

The image processing section 40 receives the coordinates of the vertex of each polygon computed by the game space arithmetic section 26 in the game operation section 20, and stores the image information in the circular frame buffer 50 to display the image on the spherical screen 4. The image processing section 40 comprises a plane processing section 41, an image information transferring section 45, and a correspondence coordinate setting section 46. The plane processing section 41 projects an image of a 3-dimensional object arranged in the game space onto the plurality of virtual planes surrounding the spherical screen 4. The image information transferring section 45 reads the 2-dimensional image projected onto the virtual planes by the plane processing section 41, and performs the process of transferring the image information to be stored in the circular frame buffer 50. Additionally, the correspondence coordinate setting section 46 associates the coordinates required in the transferring process.

The image processing section 40 is realized by using an exclusive graphic LSI, DSP, etc. However, when the performance of the CPU for realizing the game operation section 20 is high, and there is sufficient throughput, then the CPU can be allowed to perform the process to be performed by the image processing section 40.

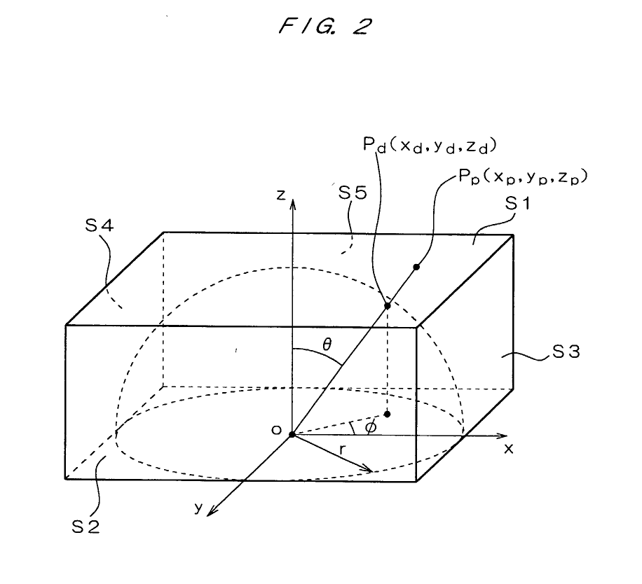

FIG. 2 shows a virtual plane used by the plane processing section 41 performing a projecting process. As shown in FIG. 2, it is assumed that five planes S1, S2, S3, S4, and S5 surround the hemispheric spherical screen 4. These five planes S1 through S5 correspond to the respective planes obtained by cutting the rectangular parallelepiped surrounding the sphere forming the spherical screen 4, and the adjacent planes make a right angle.

The plane processing section 41 comprises a perspective projection converting. section 42, a texture mapping process section 43, and a flat buffer 44. The perspective projection converting section 42 sets the sphere center position of the spherical screen 4 as a virtual eyepoint location, and performs a perspective projection converting process by projecting various 3-dimensional objects arranged in the game space onto the above mentioned five planes S1 through S5 as a virtual screen. According to the present embodiment, each of the 3-dimensional objects is configured by one or more polygons, and a coordinate converting process of projecting the coordinates of the vertexes of the polygons arranged in the game space onto the respective planes S1 through S5 in the perspective projection converting process.

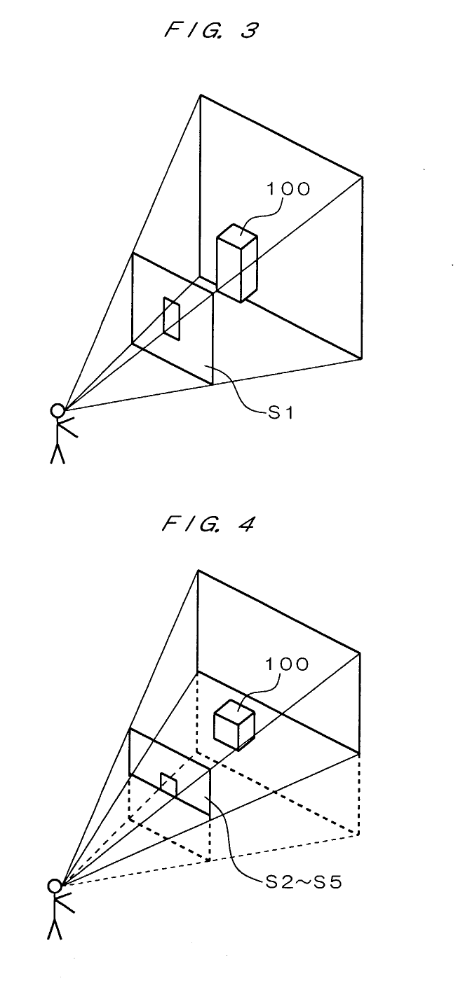

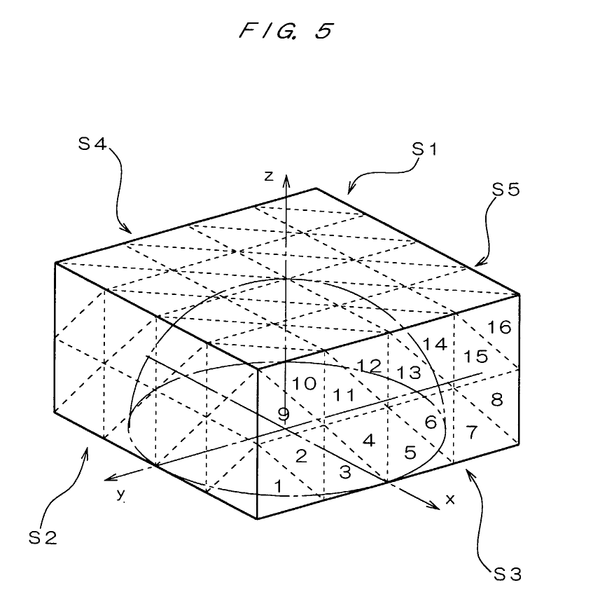

FIGS. 3 and 4 show practical examples of the perspective projection conversion. The perspective projection conversion on the plane S1 of a square is performed by projecting a 3-dimensional objects 100 arranged in the game space onto the plane S1 as shown in FIG. 3. The perspective projection conversion on the other planes S2 through S5 can be performed using only the upper half of the plane of the square as in the case of the plane S1 as shown in FIG. 4.

The texture mapping process section 43 performs the process (texture mapping process) of applying texture data to the inside of each polygon whose vertex positions on the planes S1 through S5 are computed in the perspective projection conversion. Thus, the process of projecting the 3-dimensional objects onto the respective planes S1 through S5 is performed, and the obtained 2-dimensional image information is stored in the flat buffer 44. Thus, a picture around the eyepoint in the game space is generated on the planes S1 through S5.

Since the above mentioned perspective projection converting process and the texture mapping process are the same as the processes of the conventional technology, the existing hardware and software developed and marketed for 3-dimensional image process can be used as is.

The image information transferring section 45 performs the process of transferring the 2-dimensional image information obtained for each of the five planes S1 through S5 shown in FIG. 2 to the corresponding area of the circular frame buffer 50 in the texture mapping method.

FIGS. 5 to 7 show the outline of the texture mapping process performed by the image information transferring section 45. FIG. 5 shows a practical example of a plurality of sectioned areas corresponding to the five respective and virtual planes S1 through S5. According to the present embodiment, a process is performed on the sectioned area as in the process on the polygon (for example, the texture mapping process, etc.)

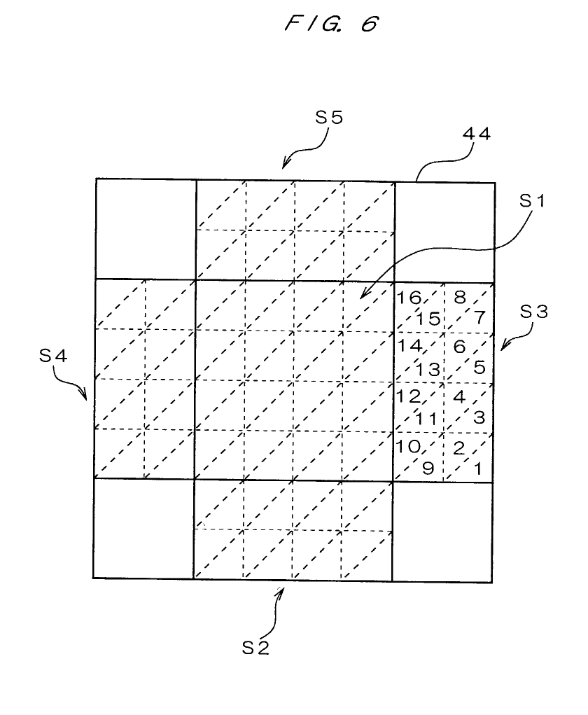

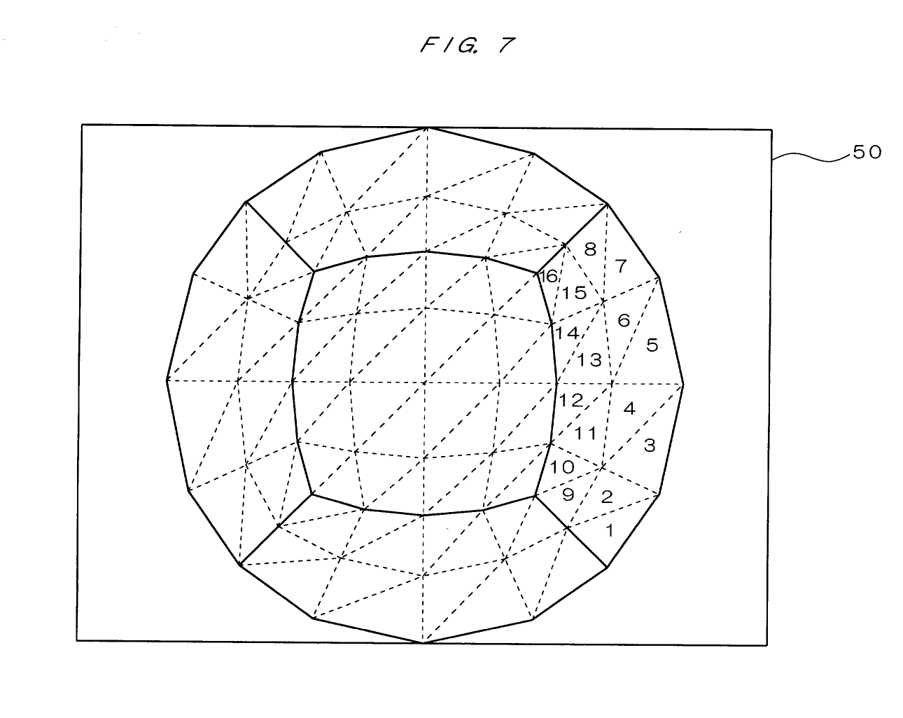

FIG. 6 shows the correspondence between the image information stored in the flat buffer 44 and the sectioned area forming each plane. FIG. 7 shows the correspondence among the sectioned areas in the circular frame buffer 50. In the actual process, the sectioned area is processed as the polygon forming part of a 3-dimensional object. For example, according to the present embodiment, a process equivalent to the texture mapping process is performed on the sectioned area. These figures refer to the view of the shape shown in FIG. 5 in the z-axis direction (from above in FIG. 5) from the positive side to the origin.

As shown in FIG. 5, for example, it is assumed that the plane S3 is formed by the sixteen sectioned areas respectively assigned the reference numerals 1 to 16. In this case, the image information generated by the above mentioned perspective projection converting section 42 and the texture mapping process section 43 is stored in the storage area of the flat buffer 44 corresponding to the plane S3. Like the polygons obtained by dividing the plane S3, this image information is divided into the sixteen sectioned areas respectively assigned the reference numerals 1 to 16 as shown in FIG. 6. This is more comprehensible when the texture mapping method is taken into account. If the image information stored in the storage areas of a flat buffer 44 corresponding to the plane S3 is the texture data, each of the vertexes of the sectioned areas obtained by dividing the plane S3 corresponds to the texture coordinates obtained by dividing the storage area of the flat buffer 44 corresponding to the plane S3.

A vertex in a virtual space can be converted into coordinates in the circular frame buffer 50. Therefore, the sectioned areas obtained by dividing the above mentioned planes S1 through S5 are converted into the sectioned areas in the circular frame buffer 50. The values are set by the correspondence coordinate setting section 46. Using the values, the sixteen sectioned areas respectively assigned the reference numerals 1 to 16 in the planes S3 shown in FIG. 5 are converted into the sixteen sectioned areas assigned the reference numerals 1 to 16 shown in FIG. 7. Similar conversion is performed on other planes. In the conversion, image information is transferred such that the sectioned areas converted into the circular frame buffer 50 by the texture coordinates specified above can be filled, and the image information is written to the entire circular frame buffer 50 as shown in FIG. 7.

In the example shown in FIG. 6, each of the planes S1 through S5 is extended, and the image information is stored in the flat buffer 44 for easy comprehension. However, the storage areas in the flat buffer 44 can be arbitrarily assigned, and the image information can be distributed and stored in the flat buffer 44 physically using two or more memory sections, etc.

The correspondence coordinate setting section 46 sets the storage coordinates in the circular frame buffer 50 corresponding to the coordinates of the vertex of each sectioned area shown in FIG. 5. There can be various setting methods. For example, each time the image information transferring section 45 performs a transferring process (texture mapping process) on the image information, the corresponding storage coordinates can be computed. However, considering that the number and the shape of the sectioned areas forming each of the planes S1 through S5 shown in FIG. 5 are fixed, It is desirable that the storage coordinates in the circular frame buffer 50 corresponding to each vertex of the sectioned area are computed in advance, and the result is stored. A practical example of computing the storage coordinates is described later.

The above mentioned projector 2 corresponds to the projection device, the plane processing section 41 corresponds to the plane processing unit, the image information transferring section 45 corresponds to the image information transferring unit, the correspondence coordinate setting section 46 corresponds to the corresponding coordinate setting unit, and the game space arithmetic section 26 corresponds to the object computation unit.

The game system according to the present embodiment is configured as described above, and the operations of the system will be described below.

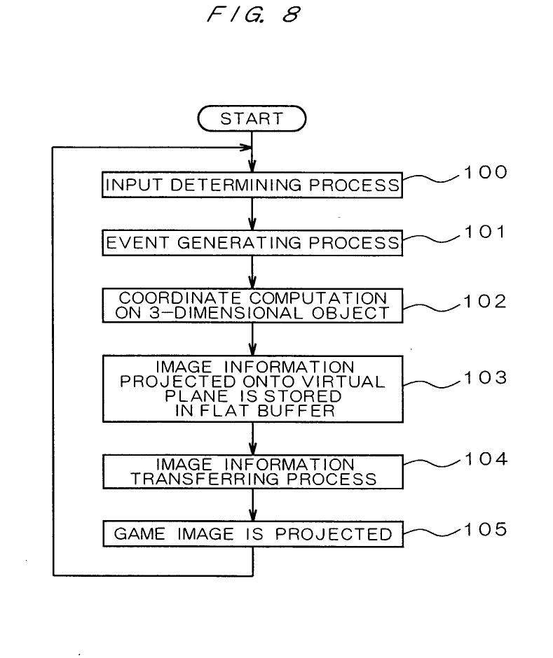

FIG. 8 is a flowchart showing an outline of the operation procedure of a game system according to the present embodiment, and shows the flow of the entire game. A series of processes shown in FIG. 8 are repeatedly performed in a period corresponding to a predetermined display interval (for example, 1/60 second).

When an instruction to start the game is issued by a player by operating the input device 10, the game operation section 20 starts a predetermined game arithmetic operation according to the game program read from the information storage medium 30. Practically, the input determination section 22 in the game operation section 20 performs a predetermined input determining process of outputting a signal corresponding to the contents of the operation performed by the player according to the signal output from the input device 10 (step 100).

Then, the event processing section 24 performs a process (event generating process) of generating various events required for the progress of the game in response to the signal output from the input determination section 22 (step 101). The game space arithmetic section 26 performs coordinate computation on various 3-dimensional objects existing in the game space in response to the event generating process performed by the event processing section 24 (step 102). In the coordinate computation, each of the coordinates of the vertexes of a plurality of polygons forming a 3-dimensional object is computed.

Thus, when the positional information about the 3-dimensional object is obtained by performing the coordinate computation of each 3-dimensional object by the game space arithmetic section 26, the plane processing section 41 in the image processing section 40 performs the perspective projection conversion based on a predetermined eyepoint location, and stores the image information corresponding to the virtual five planes S1 through S5 in the flat buffer 44 (step 103). Practically, the perspective projection converting section 42 computes the coordinates of the vertexes of the polygons forming the 3-dimensional objects in the game space, the texture mapping process section 43 obtains the image information in the polygons, and the image information is stored in the flat buffer 44.

Then, the image information transferring section 45 performs the process of transferring image information by reading the image information corresponding to each of the plurality of sectioned areas forming the planes S1 through S5 from the flat buffer 44, and storing the information in the-corresponding area of the circular frame buffer 50 (step 104). As described above, the process of storing the image information in the circular frame buffer 50 for each sectioned area is performed as in the conventional texture mapping process. Since the shape and the position of each sectioned area forming part of the planes S1 through S5 are fixed, it is not necessary to perform the process of computing the storage coordinates in the circular frame buffer 50 corresponding to each vertex each time, but a computed result can be read and used.

The image information written to the circular frame buffer 50 is read in the predetermined scanning order, and transmitted to the projector 2. The projector 2 forms an image according to the image information, and projects the image onto the spherical screen 4 through the lens 3 (step 105).

Thus, the game image of the new contents is generated and projected onto the spherical screen 4 in a predetermined repeating period. In the above mentioned explanation of the operations, the drawing process is performed by performing a series of processes shown in FIG. 8 in a period corresponding to a display interval, but the display interval does not necessarily have to match the repeating period of the drawing process. Otherwise, if the drawing process is performed in synchronization with the display timing each time when the drawing process can follow the display timing, and the screen display is performed using the same contents when it cannot follow the display timing, then the display timing may not match the drawing timing.

Described below in detail is the process of setting the storage coordinates in the circular frame buffer 50 corresponding to the vertexes of a sectioned area in the above mentioned correspondence coordinate setting section 46.

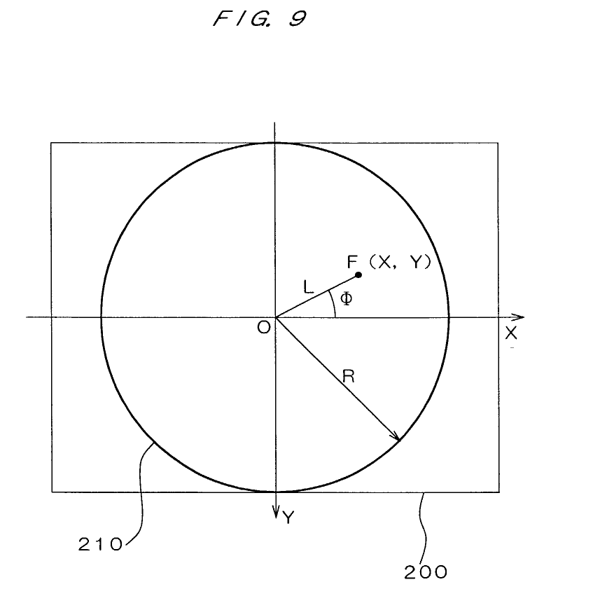

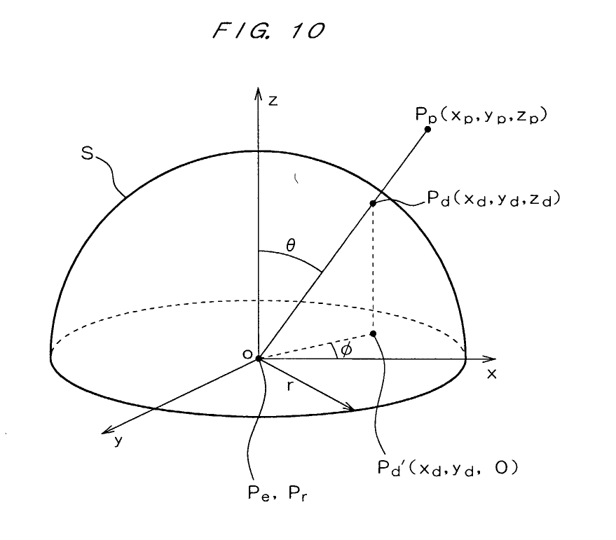

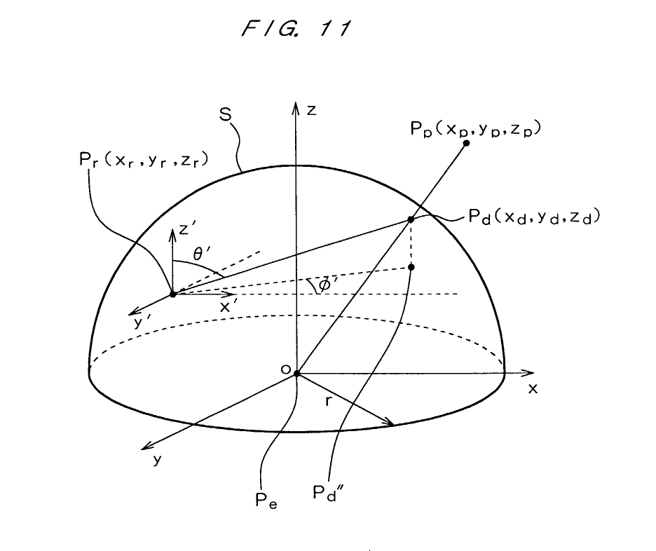

FIG. 9 shows a drawing range in the circular frame buffer 50. The projector 2 according to the present embodiment has a rectangular parallelepiped having horizontal sides longer than vertical sides (for example, an aspect ratio is 3:4), and a part of the areas is used as a drawing area corresponding to an image to be projected onto the spherical screen 4. FIG. 9 corresponds to the case in which the projection surface S shown in FIG. 10 described later is viewed in the Z-axis direction from the positive side to the origin (from above in FIG. 10).

In FIG. 9, a rectangular area 200 corresponds to the projection range of the projector 2, and a circular area 210 corresponds to the range in the spherical screen 4 onto which an image is projected through the lens 3. Therefore, according to the present embodiment, the image information is written only to the range in the circular area 210 among the coordinates in the circular frame buffer 50.

As shown in FIG. 9, the X axis refers to the horizontal direction and the Y axis refers to the vertical direction. The center (center of a circle) of the circular area 210 is an origin O, and the radius of the circular area 210 is represented by R. The image information stored at an arbitrary point F (X, Y) in the circular frame buffer 50 is projected at the point P_{d} on the spherical screen 4.

(1) When Both Eyepoint Location and Projection Position are Set in the Sphere Center Position on the Spherical Screen 4

FIG. 10 shows an outline of the coordinate converting process. As shown in FIG. 10, the hemispheric projection surface corresponding to the spherical screen 4 is represented by S, and the sphere center of the projection surface S is set to origin O Then, the axis extending from the origin O to the plane center of the projection surface S is defined as a z axis, and axes extending perpendicular to the z axis are defined as an x axis and a y axis. In this example, it is assumed that the eyepoint location Pₑ of the player and the projection position (position of the lens 3) Pᵣ match the origin O.

Assume that an arbitrary point Pₚ (xₚ, yₚ, zₚ) in the game space, which is a 3-dimensional space, is mapped onto the point F (X, Y) in the circular frame buffer 50. In FIG. 10, when the point Pₚ (xₚ, yₚ, zₚ) in the game space is viewed from the origin O, the intersection of the line from the point Pₚ to the origin O and the projection surface S is defined as the point P_{d} (x_{d}, y_{d}, z_{d}) . If the radius of the hemisphere corresponding to the projection surface S is represented by r, then x_{d}, y_{d}, and z_{d} are represented by the following equations.

$$\begin{matrix}{x}_{d} = \frac{{x}_{p} \times r}{\sqrt{{x}_{p}^{2} + {y}_{p}^{2} + {z}_{p}^{2}}} & ( 1 ) \\ {y}_{d} = \frac{{y}_{p} \times r}{\sqrt{{x}_{p}^{2} + {y}_{p}^{2} + {z}_{p}^{2}}} & ( 2 ) \\ {z}_{d} = \frac{{z}_{p} \times r}{\sqrt{{x}_{p}^{2} + {y}_{p}^{2} + {z}_{p}^{2}}} & ( 3 )\end{matrix}$$

Additionally, in FIG. 10, assuming that the angle θ is made between the line from the origin O to the point P_{d} and the z axis, the angle θ is represented by the following equation.

$$θ = {cos}^{- 1} ( \frac{{z}_{d}}{r} )$$

The lens 3 used in the present embodiment has the characteristic that the distance L from the origin O to the point F is proportional to the angle θ shown in FIG. 10 when the point F (X, Y) shown in FIG. 9 is projected onto the projection surface S. Therefore, the distance L=0 when θ=0, and the distance L=R when θ=π/2. The distance L corresponding to an arbitrary angle θ with these settings can be represented by the following equation.

L=θ/(π/2)×R

In FIG. 9, assume that an angle Φ is made between the line from the origin O to the point F (X, Y) and the x axis in the circular frame buffer 50. In FIG. 10, assume that an angle φ is made between the line from the mapping point P_{d}′ (X_{d}, Y_{d}, 0) obtained by mapping the point P_{d} (x_{d}, y_{d}, z_{d}) onto the xy plane to the origin O and the x axis. The angle Φ equals the angle φ. The cos φ and sin φ can be represented by two following equations.

$$cos φ = \frac{{x}_{d}}{\sqrt{{x}_{d}^{2} + {y}_{d}^{2}}}$$

$$sin φ = \frac{{y}_{d}}{\sqrt{{x}_{d}^{2} + {y}_{d}^{2}}}$$

The point F (X, Y) can be represented by the following equation using the coordinates of each axis at the point P_{d} (x_{d}, y_{d}, z_{d}) on the projection surface S.

$$\begin{matrix}\begin{matrix}X = L \times cos Φ \\ = \frac{θ}{π / 2} \times R \times cos φ \\ = \frac{2 R}{π} \times {cos}^{- 1} ( \frac{{z}_{d}}{r} ) \times \frac{{x}_{d}}{\sqrt{{x}_{d}^{2} + {y}_{d}^{2}}}\end{matrix} & ( 4 ) \\ \begin{matrix}Y = L \times sin Φ \\ = \frac{θ}{π / 2} \times R \times sin φ \\ = \frac{2 R}{π} \times {cos}^{- 1} ( \frac{{z}_{d}}{r} ) \times \frac{{y}_{d}}{\sqrt{{x}_{d}^{2} + {y}_{d}^{2}}}\end{matrix} & ( 5 )\end{matrix}$$

Therefore, when the vertex Pₚ (xₚ, yₚ, zₚ) of each of the polygons forming the 3-dimensional objects arranged in the game space is discovered, the corresponding storage position in the circular frame buffer 50 is computed by the correspondence coordinate setting section 46 computing the coordinates of the point Pd (x_{d}, y_{d}, z_{d}) on the projection surface S by substituting the coordinates of the vertex Pₚ (xₚ, yₚ, zₚ) for the above mentioned equations (1) to (3). Then, the correspondence coordinate setting section 46 substitutes the coordinates of the point P_{d} (x_{d}, y_{d}, z_{d}) obtained by the computation for the above mentioned equations (4) and (5), thereby computing the point F (X, Y) in the circular frame buffer 50.

Thus, the storage coordinates in the circular frame buffer 50 corresponding to each vertex (Pₚ) of a plurality of sectioned areas forming the planes S1 through S5 can be obtained. Especially, since the computation of the coordinates is correctly performed by taking the eyepoint location and the projection position taken into account, the storage coordinates can be obtained in the circular frame buffer 50 required to project a correct and logically distortion-free game image as viewed from the eyepoint location onto the spherical screen 4.

Furthermore, if linear interpolation is performed on an internal area specified by the vertex of each sectioned area when image information is transferred from the flat buffer 44 to the circular frame buffer 50, then the function of hardware for performing the texture mapping process can be used, thereby shortening the processing time (transfer time) and reducing the necessary cost.

(2) When Only the Projection Position is Deviated From the Sphere Center of the Spherical Screen 4

In the explanation above, the eyepoint location Pₑ and the projection position Pᵣ match the sphere center of the spherical screen 4. However, it is practically hard to realize such positional relationship. When the actual geometric arrangement is considered, it is desirable that the eyepoint location of the player is set near the sphere center of the spherical screen 4 to allow the player to view a highly realistic game image using the spherical screen 4. Therefore, in this case, it is necessary to set the projection position Pᵣ off the sphere center of the spherical screen 4.

FIG. 11 shows an outline of a coordinate converting process performed when the projection position is changed from the sphere center position of the spherical screen 4. The coordinate axis shown in FIG. 11 is the same as that shown in FIG. 10. The projection position Pᵣ (xᵣ, yᵣ, zᵣ) is set in a predetermined position (for example, above the head of the player, etc.) other than the sphere center of the spherical screen 4. Since the origin of the circular frame buffer 50 corresponds to the projection position Pᵣ, the origin is set as O′ to distinguish it from the display of the coordinate axis (FIG. 9) in the case (1) above, and the axis in the horizontal direction is set as an x′ axis while the axis in the vertical direction is set as a y′ axis.

As explained in (1) above, when the eyepoint location Pₑ matches the position of the origin O corresponding to the sphere center of the spherical screen 4, the point Pₚ (xₚ, yₚ, zₚ) in the game space appears as the point P_{d} (x_{d}, y_{d}, z_{d}) on the projection surfaces. That is, if the point is projected from an arbitrary projection position Pᵣ onto the point P_{d} (x_{d}, y_{d}, z_{d}) on the spherical screen 4, the point is recognized as the point Pₚ (xₚ, yₚ, zₚ) in the game space from the eyepoint location Pₑ.

Therefore, if the coordinate converting process similar to the procedure described in (1) above is performed on the arbitrary projection position Pᵣ, then the point F′ (X′, Y′) in the circular frame buffer 50 required in projecting the point from the projection position Pᵣ to the point P_{d} can be obtained. However, the x′ axis, the y′ axis, and the z′ axis obtained by shifting the projection position Pᵣ from the origin O have been obtained by moving the original x, y, and z axes in parallel, and no rotation around the axes are assumed. Furthermore, it is assumed that the projection position Pᵣ is set in the range of xᵣ²+yᵣ²+zᵣ²<r² (between the origin O and the radius r).

In FIG. 11, assuming that an angle θ′ is made between the line from the projection position Pᵣ to the point P_{d} and the z′ axis, the angle θ′ is represented by the following equation.

$${θ}^{′} = {cos}^{- 1} ( \frac{{z}_{d} - {z}_{r}}{\sqrt{{( {x}_{d} - {x}_{r} )}^{2} + {( {y}_{d} - {y}_{r} )}^{2} + {( {z}_{d} - {z}_{r} )}^{2}}} ) \qquad ( 6 )$$

Assuming that an angle Φ′ is made between the line from the origin O′ to the point F′ (X′, Y′) and the x′ axis in the circular frame buffer 50, and an angle φ′ is made as shown in FIG. 10 between the line from the mapping point P_{d}″ (x_{d}−xᵣ, y_{d}−y_{r,} 0) obtained by mapping the point P_{d} (x_{d}, y_{d}, z_{d}) to the x′y′ plane to the point Pᵣ and the x′ axis, the angle Φ′ equals the angle φ′ where cos φ′ and sin φ′ are represented by the following equation.

$$cos {φ}^{′} = \frac{{x}_{d} - {x}_{r}}{\sqrt{{( {x}_{d} - {x}_{r} )}^{2} + {( {y}_{d} - {y}_{r} )}^{2}}}$$

$$sin {φ}^{′} = \frac{{y}_{d} - {y}_{r}}{\sqrt{{( {x}_{d} - {x}_{r} )}^{2} + {( {y}_{d} - {y}_{r} )}^{2}}}$$

Furthermore, the coordinates of the point P_{d} (x_{d}, y_{d}, z_{d}) on the projection surface S are obtained by the equations (1) to (3) above.

The point F′ (X′, Y′) can be represented by the following equations using the coordinates of the point P_{d} (x_{d}, y_{d}, z_{d}) on the projection surface S and the projection position Pᵣ (xᵣ, yᵣ, zᵣ).

$$\begin{matrix}\begin{matrix}{X}^{′} = \frac{{θ}^{′}}{π / 2} \times R \times cos {Φ}^{′} \\ = \frac{{θ}^{′}}{π / 2} \times R \times cos {φ}^{′} \\ = \frac{2 R}{π} \times {cos}^{- 1} ( \frac{{z}_{d} - {z}_{r}}{\sqrt{{( {x}_{d} - {x}_{r} )}^{2} + {( {y}_{d} - {y}_{r} )}^{2} + {( {z}_{d} - {z}_{r} )}^{2}}} ) \times \\ \frac{{x}_{d} - {x}_{r}}{\sqrt{{( {x}_{d} - {x}_{r} )}^{2} + {( {y}_{d} - {y}_{r} )}^{2}}}\end{matrix} & ( 7 ) \\ \begin{matrix}{Y}^{′} = \frac{{θ}^{′}}{π / 2} \times R \times sin {Φ}^{′} \\ = \frac{{θ}^{′}}{π / 2} \times R \times sin {φ}^{′} \\ = \frac{2 R}{π} \times {cos}^{- 1} ( \frac{{z}_{d} - {z}_{r}}{\sqrt{{( {x}_{d} - {x}_{r} )}^{2} + {( {y}_{d} - {y}_{r} )}^{2} + {( {z}_{d} - {z}_{r} )}^{2}}} ) \times \\ \frac{{y}_{d} - {y}_{r}}{\sqrt{{( {x}_{d} - {x}_{r} )}^{2} + {( {y}_{d} - {y}_{r} )}^{2}}}\end{matrix} & ( 8 )\end{matrix}$$

Therefore, when the vertex Pₚ (xₚ, yₚ, zₚ) of each polygon forming part of the 3-dimensional objects arranged in the game space is obtained, the correspondence coordinate setting section 46 first substitutes the coordinates of the vertex Pₚ (xₚ, yₚ, zₚ) for the above equations (1) to (3) to compute the corresponding storage position in the circular frame buffer 50, thereby computes the coordinates of the point P_{d} (x_{d}, y_{d}, z_{d}) on the projection surface S. Then, the correspondence coordinate setting section 46 substitutes the coordinates of the point P_{d} (x_{d}, y_{d}, z_{d}) obtained by the computation for the above equations (7) and (8), thereby computes the coordinates of the point F′ (X′, Y′) in the circular frame buffer 50.

Thus, the storage coordinates in the circular frame buffer 50 corresponding to each vertex of the sectioned areas forming the respective planes S1 through S5 are obtained. Especially, since the above mentioned coordinate computation is correctly performed using the eyepoint location and the projection position, the storage coordinates in the circular frame buffer 50 required to project a correct and logically distortion-free game image viewed from the eyepoint location onto the spherical screen 4 can be obtained although the projection position is moved to any position.

In FIG. 11 above, the projection position Pᵣ is drawn in the area where zᵣ≧0 for convenience in explanation. However, since the projection angle of the lens 3 is practically 180 degrees, it is desirable that the projection position Pᵣ is set in the range of zᵣ≦0 to display the game image on the entire spherical screen 4.

Since the fisheye lens used as the lens 3 according to the present embodiment generally has a long depth of focus, the lens comes into focus in a wide range. Therefore, although the projection position is shifted, the game image displayed on the spherical screen 4 is totally in focus.

(3) When Both Eye Point Location and Projection Position are Deviated from the Sphere Center of the Spherical Screen 4

In the explanation (2) above, the projection position Pᵣ is set in the position off the sphere center position of the spherical screen 4. Practically, it may also be desired to deviate the eyepoint location Pₑ of the player from the sphere center position of the spherical screen 4. Described below is the case in which both eyepoint location and projection position are deviated from the sphere center position of the spherical screen 4.

So far, the eyepoint is set in the sphere center position of the spherical screen 4. However, when the eyepoint moves, the relationship among the spherical screen 4, the eyepoint, and the planes S1 through S5 changes. It has been considered that the planes S1 through S5 surround the spherical screen 4 with the sphere center position set as the base point when the eyepoint is in the sphere center position of the spherical screen 4. However, when the eyepoint moves, it is assumed that the base point (center) is set as the eyepoint on the planes S1 through S5.

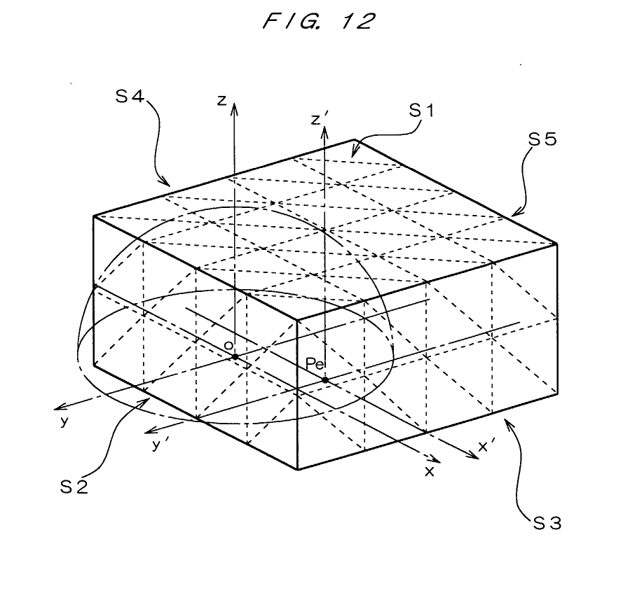

FIG. 12 shows the positional relationship between the spherical screen 4 and the planes S1 through S5 when the eyepoint deviates from the sphere center position of the spherical screen 4. The origin O of the game space is set in the sphere center position of the spherical screen 4. When the eyepoint location Pₑ (xₑ, yₑ, zₑ) moves off the origin O (in FIG. 12, the eyepoint Pₑ moves in the positive direction along the x axis, in the negative direction along the y axis, and in the negative direction along the z axis), the planes S1 through S5 with the eyepoint Pₑ set as the center are assumed as shown in FIG. 12. These planes S1 through S5 can be considered to be obtained by moving in parallel the planes S1 through S5 set when the eyepoint Pₑ is in the sphere center position of the spherical screen 4 by each axis element in moving the eyepoint Pₑ. The process is the same as the process performed when the eyepoint is set on the origin O .

Then, the coordinates conversion process is performed on the vertex of each sectioned area forming part of the planes S1 through S5 using the relational expression between an arbitrary position Pᵣ in the game space and the point F in the circular frame buffer 50. At this time, since it can be considered that the planes S1 through S5 have been moved in parallel by the movement of the eyepoint Pₑ from the origin O as described above, it is necessary to be careful that the equation for each plane is to be changed for the movement.

Plane S1: z=r+zₑ

(where −r+xₑ≦x≦r+xₑ, −r+yₑ≦y≦r+yₑ)

Plane S2: y=r+yₑ

(where −r+xₑ≦x≦r+xₑ, zₑ≦z≦r+zₑ)

Plane S3: x=r+xₑ

(where −r+yₑ≦y≦r+yₑ, zₑ≦z≦r+zₑ)

Plane S4: x=−r+xₑ

(where −r+yₑ≦y≦r+yₑ, zₑ≦z≦r+zₑ)

Plane S5: z=−r+yₑ

(where −r+xₑ≦x≦r+xₑ, zₑ≦z≦r+zₑ)

FIG. 13 shows an outline of the coordinate converting process when the eyepoint location and the projection position deviate from the sphere center position of the spherical screen.

For example, assuming that the intersection of the line expressed by the equation

$$\frac{x - {x}_{e}}{{x}_{p} - {x}_{e}} = \frac{y - {y}_{e}}{{y}_{p} - {y}_{e}} = \frac{z - {z}_{e}}{{z}_{p} - {z}_{e}} \qquad ( 9 )$$

connecting one vertex point Pₚ (xₚ, yₚ, zₚ) of a sectioned area forming part of the plane S1 with the eyepoint Pₑ (xₑ, yₑ, zₑ) and the spherical screen 4 represented by the equation r²=x²+y²+z² is point P_{d} (x_{d}, y_{d}, z_{d}). Based on the relationship between the point P_{d} and the projection point Pᵣ (xᵣ, yᵣ, zᵣ), the point F (X, Y) in the circular frame buffer 50 can be derived. The computation expression is the same as in the case in which the eyepoint Pₑ is set on the origin O.

Thus, the corresponding coordinates in the circular frame buffer 50 corresponding to each vertex of a sectioned area forming part of the planes S1 through S5 are obtained. Especially, since the above mentioned coordinate computation is correctly performed by using the eyepoint location and the projection position, in the projection point on the circular frame buffer 50 required to project a correct and logically distortion-free game image viewed from the eyepoint location onto the spherical screen 4 can be obtained although the eyepoint location and projection position are moved to any position.

In FIG. 13 above, the projection position Pᵣ is drawn in the area where Zᵣ≧0 for convenience in explanation. However, for same reason as in (2) above, it is desirable that the actual projection position Pᵣ is set in the range of Zᵣ≦0.

Thus, in the game system according to the present embodiment, the image information about a 3-dimensional object is projected onto the five planes S1 through S5 surrounding the spherical screen 4 and then stored in the flat buffer 44. The image information stored in the flat buffer 44 is transferred to the circular frame buffer 50 in the texture mapping method. In the perspective projection converting process performed on the planes S1 through S5 and the transferring process to the circular frame buffer 50, the eyepoint location and the projection position are taken into account, and the shape of the 3-dimensional object viewed from the eyepoint location is correctly regenerated, thereby reducing the distortion of the image projected onto the spherical screen 4.

Especially, in the process of projecting a 3-dimensional object onto each of the planes S1 through S5, the computing method, exclusive hardware, etc. commonly used in the field of the conventional game systems, computer graphics, etc. can be used. Therefore, the process can be quickly performed and the developing steps for the process can be reduced, thereby reducing the cost required for the process.

Furthermore, the process performed by the image information transferring section 45 is a common texture mapping process in which the flat buffer 44 is used as texture memory, the coordinates of the vertex of each sectioned area forming part of the planes S1 through S5 are fixed, the result of the first computation result can be used in the subsequent steps, and a coordinates table, etc. storing the value obtained in the preliminary computation steps can be used. As a result, it is not necessary to compute the coordinates of a vertex, thereby reducing the necessity of computing the coordinates of the vertex each time they are used and quickly performing the process.

Furthermore, by setting the number of planes onto which the image information about a 3-dimensional object is to be projected to five, the forward periphery of the eyepoint Pₑ can be completely covered by the planes, thereby transferring the image information about the 3-dimensional object in the view direction to the circular frame buffer 50 with reliability.

The present invention is not limited to the above mentioned embodiment, but can be applied to various embodiments in the range of the gist of the present invention. For example, when the projection position Pᵣ is deviated from the sphere center position of the spherical screen 4, the brightness of the image information to be stored in the circular frame buffer 50 can be amended with the distance from the projection position Pᵣ to the position P_{d} (or P_{d}′) on the spherical screen 4 taken into account.

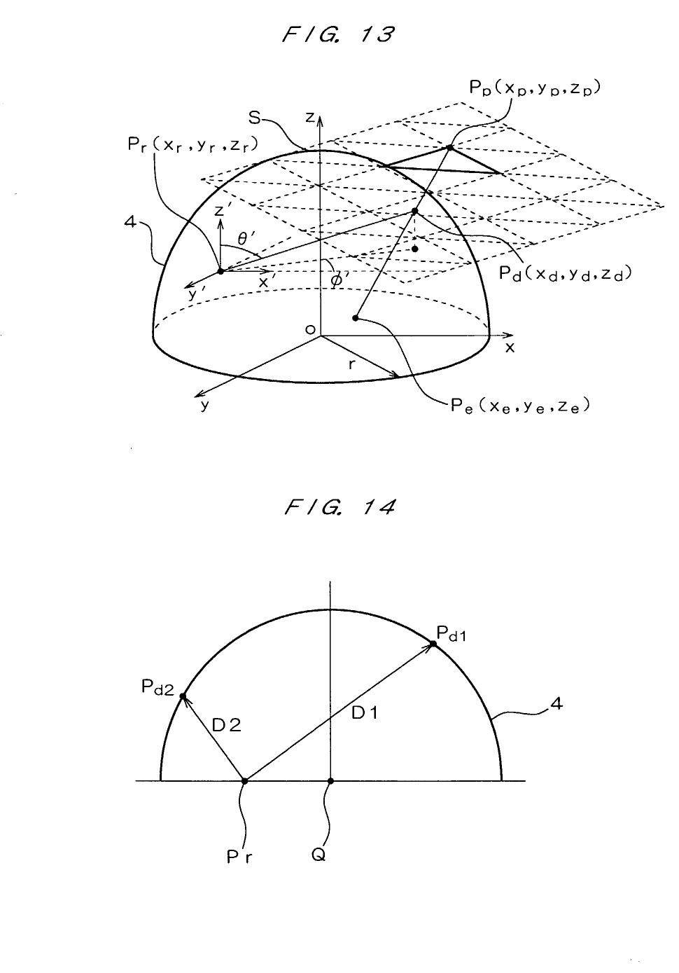

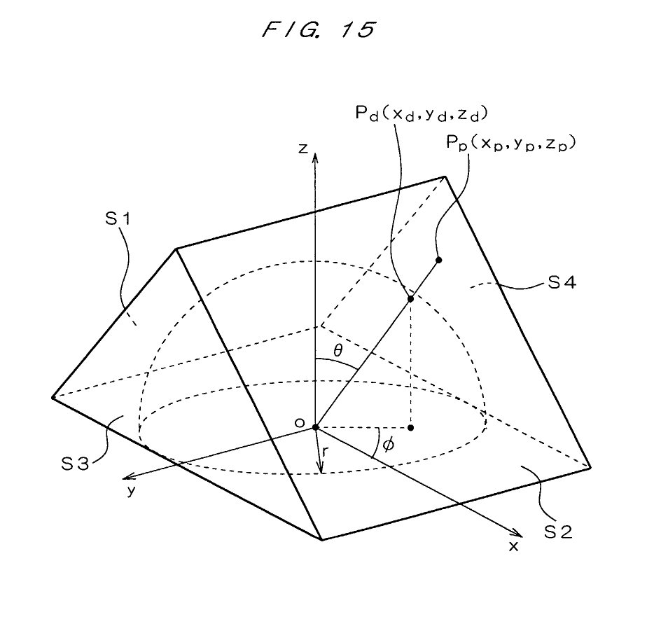

FIG. 14 shows an example of a variation of amending the brightness, and shows a simple view of the section of the spherical screen 4. When the projection position Pᵣ deviates from the sphere center position Q of the spherical screen 4, the distance from the projection position Pᵣ to an arbitrary position on the spherical screen 4 is not fixed. For example, as shown in FIG. 14, the distance D1 from the projection position Pᵣ to a point P_{d1} on the spherical screen 4 is quite different from the distance D2 from the projection position Pr to another point P_{d2}. Since the intensity of the light (light corresponding to each pixel forming part of a game image) emitted from the projection position Pᵣ, that is, the brightness, varies inversely with the square of the distance, there occurs deviation in the brightness of the game image displayed on the spherical screen 4.

Therefore, for example, if a predetermined coefficient varying inversely with the square of the distance from the projection position Pᵣ to a position on the spherical screen 4 is set, and the image information to be stored in the circular frame buffer 50 is multiplied by the coefficient, then the brightness of the image information can be amended. Thus, the deviation in the brightness of the game image can be reduced, thereby successfully projecting a higher quality game image.

As an easier method, for example, a predetermined coefficient varying inversely with the distance from the projection position Pᵣ to a position on the spherical screen 4 is set, and the image information to be stored in the circular frame buffer 50 can be multiplied by the coefficient. In this case, the deviation in the brightness of the game image can be reduced to some extent, and the amount of computation required to amend the brightness can also be reduced. Furthermore, since the projection angle is also relative to the distance from the projection position to a position on the spherical screen 4 onto which an image is projected, the brightness can be amended using the projection angle instead of the distance. The above mentioned amending process can be performed by the image information transferring section 45, the amending section newly added for amending the brightness, etc.

Furthermore, in the above mentioned embodiment, an image is projected onto the spherical screen which is a type of curved surface screen, but the present invention can be applied when an image is displayed on the curved surface screen other than a spherical screen if the position on the curved surface screen onto which an image is projected is computed when a 3-dimensional object arranged in the game space is viewed from an eyepoint location. For example, an image can be projected onto the curved surface screen having a projection surface obtained by halving an oval spinning body. Using such a curved surface screen, the image information read from the flat buffer 44 can be transferred to a corresponding area in the circular frame buffer 50 by obtaining the coordinates in the circular frame buffer 50 corresponding to the vertex of each sectioned area forming part of the planes S1 through S5.

Furthermore, in the above mentioned embodiment, the present invention is applied to a game system. However, the present invention can be applied to various devices for projecting a 3-dimensional image of a 3-dimensional object onto a curved surface screen. For example, the present invention can be applied to a device for presentation using a 3-dimensional object, various simulator devices such as a flight simulator, etc.

Furthermore, in the above mentioned embodiment, as shown in FIG. 2, an image of a 3-dimensional object arranged in the game space is projected onto five planes S1 through S5 surrounding the projection surface S of the spherical screen 4. These planes S1 through S5 do not have to surround the projection surface S, but can be surrounded by it, or five planes S1 through S5 have any other arbitrary values of the distance from the origin O. In the above mentioned embodiment, the adjacent planes are five planes S1 through S5 perpendicular to one another, but they can be adjacent at any angles other than 90° to one another. In this case, the number of planes can be any value other than 5.

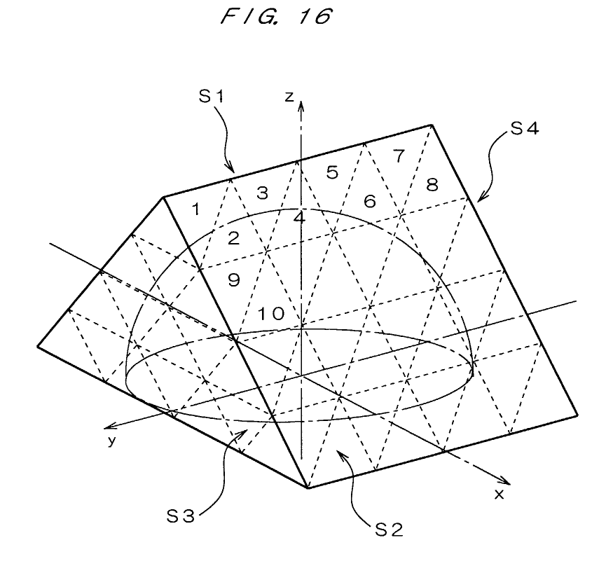

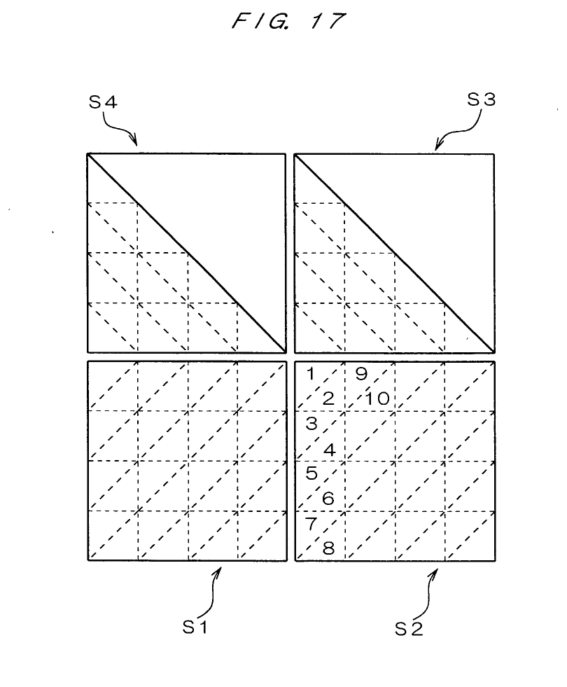

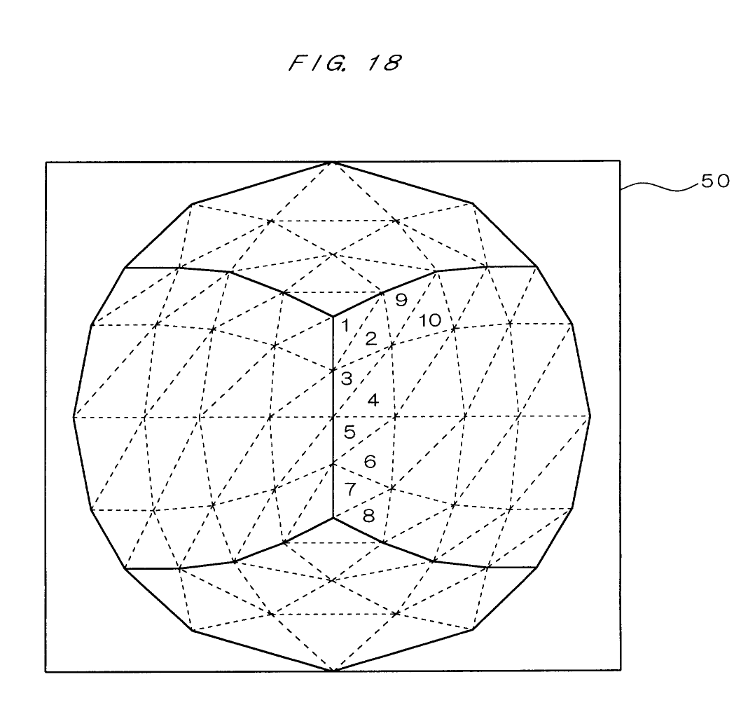

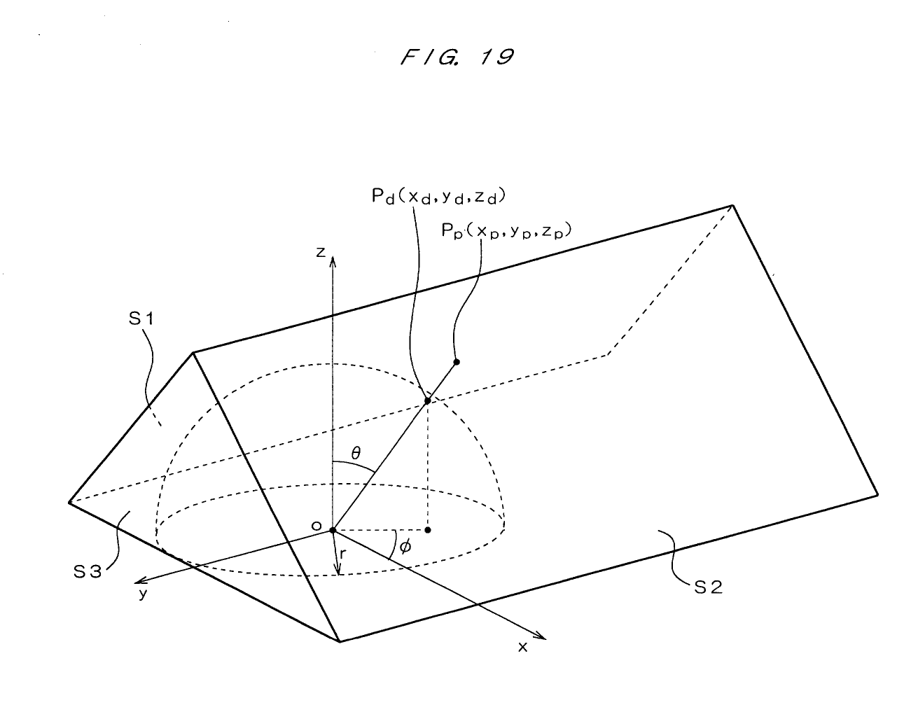

FIGS. 15 to 18 show practical examples when four planes are used in projecting an image of a 3-dimensional object, and correspond respectively to FIGS. 2, and 5 to 7. FIG. 15 shows four virtual planes S1, S2, S3, and S4 used in performing a projecting process by the plane processing section 41. These four planes S1 through S4 surround the sphere containing the spherical screen 4 (or a similar sphere), and the adjacent planes are perpendicular to each other. In these planes, the two planes S1 and S2 are square, and the other two planes S3 and S4 are right-angled isosceles triangles. FIG. 16 shows a practical example of a plurality of sectioned areas corresponding to the four virtual planes S1 through S4. FIG. 17 shows correspondence between the image information stored in the flat buffer 44 and the sectioned areas forming the four planes S1 through S4. FIG. 18 shows the correspondence between the circular frame buffer 50 and the sectioned areas of the four planes S1 through S4.

Since even the four virtual planes S1 through S4 can cover the entire spherical screen 4, the forward periphery of the eyepoint can be completely covered by the planes, thereby transferring the image information corresponding to the 3-dimensional object in the direction of the view to the circular frame buffer 50. Especially, by setting the number of the plurality of virtual planes to 4, which is 1 smaller than 5, the number of planes to be processed in the perspective projection conversion by the perspective projection converting section 42 can be reduced, thereby shortening the processing time required to perform the perspective projection conversion.

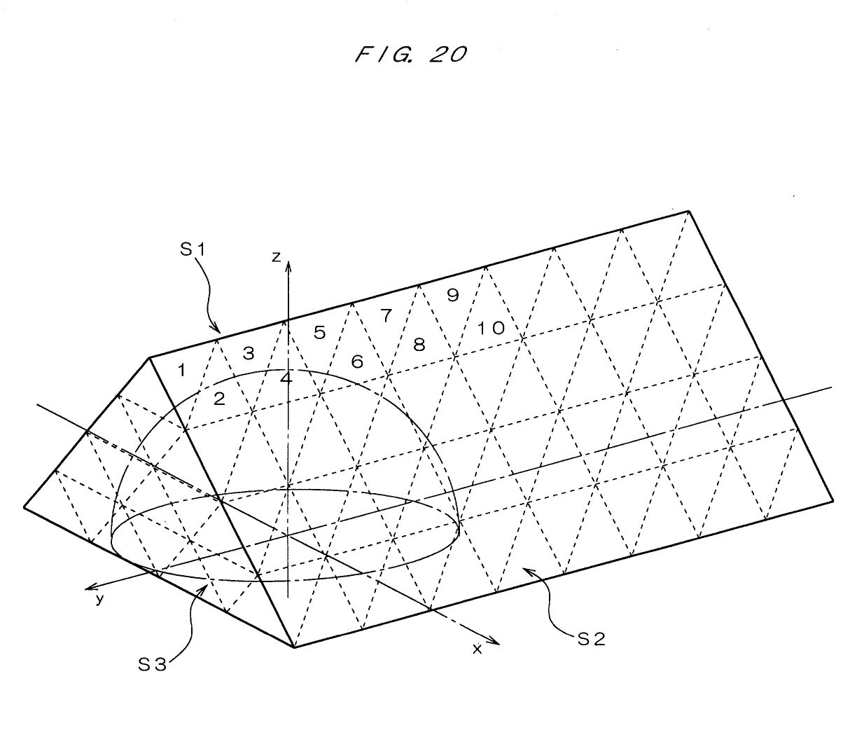

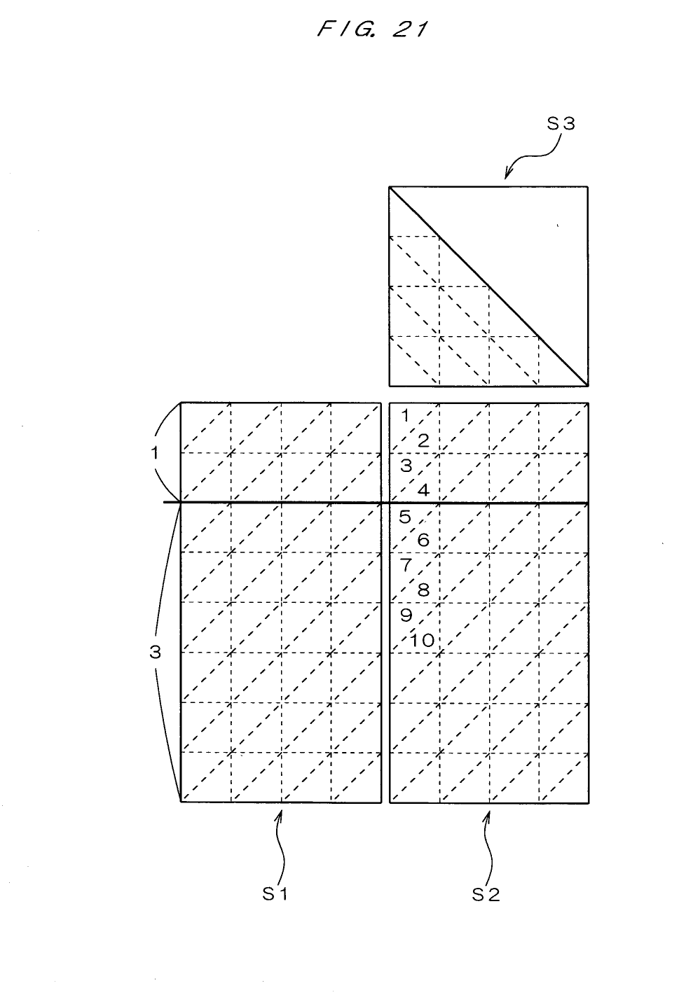

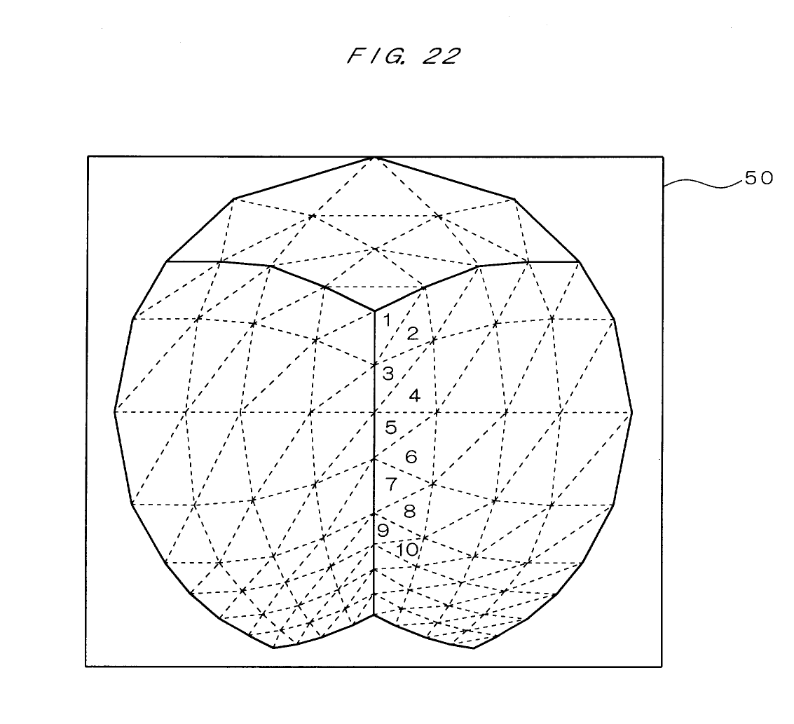

FIGS. 19 to 22 show practical examples of the cases in which a 3-dimensional object is projected using three planes, and correspond to FIGS. 2, and 5 to 7. FIG. 19 shows three virtual planes S1, S2, and S3 used in the projecting process performed by the plane processing section 41. These three planes S1 through S3 surround the sphere (or a similar sphere) containing the spherical screen 4, and adjacent planes are perpendicular to each other. Among these planes, two planes S1 and S2 are rectangular, and the remaining plane S3 is right-angled isosceles triangular. The two planes S1 and S2 shown in FIG. 19 are obtained by extending the two planes S1 and S2 shown in FIG. 15 in one direction (toward the plane S4 shown in FIG. 16), and the plane S4 shown in FIG. 16 is removed in FIG. 19. FIG. 20 shows a practical example of a plurality of sectioned areas respectively corresponding to the three virtual planes S1 through S3. FIG. 21 shows the correspondence between the image information stored in the flat buffer 44 and the sectioned areas forming the three planes S1 through S3. FIG. 22 shows the correspondence between the circular frame buffer 50 and the respective sectioned areas of the three planes S1 through S3.

Thus, since even the three virtual planes S1 through S3 can cover the substantially entire spherical screen 4, the forward periphery of the eyepoint can be substantially covered by the planes, thereby transferring the image information corresponding to the 3-dimensional object in the direction of the view to the circular frame buffer 50. Especially, by setting the number of the plurality of virtual planes to 3, which is smaller than 5 or 4, the number of planes to be processed in the perspective projection conversion by the perspective projection converting section 42 can be reduced, thereby shortening the processing time required to perform the perspective projection conversion. As shown in FIG. 22, there is a part of the substantially circular polygonal area to which image information cannot be transferred. However, when there is a portion of the spherical screen 4 which is hard to come into the view of the player, when there can be the case in which an image is not to be projected onto a part of the spherical screen 4 for any reason(for example, when apart of the spherical screen 4 is cut off for use in reserving a feet space of the player who views the image projected onto the spherical screen 4), etc., an undesired case in which a part of a projected image can be lost due to the three planes S1 through S3 as shown in FIG. 20 can be practically avoided.

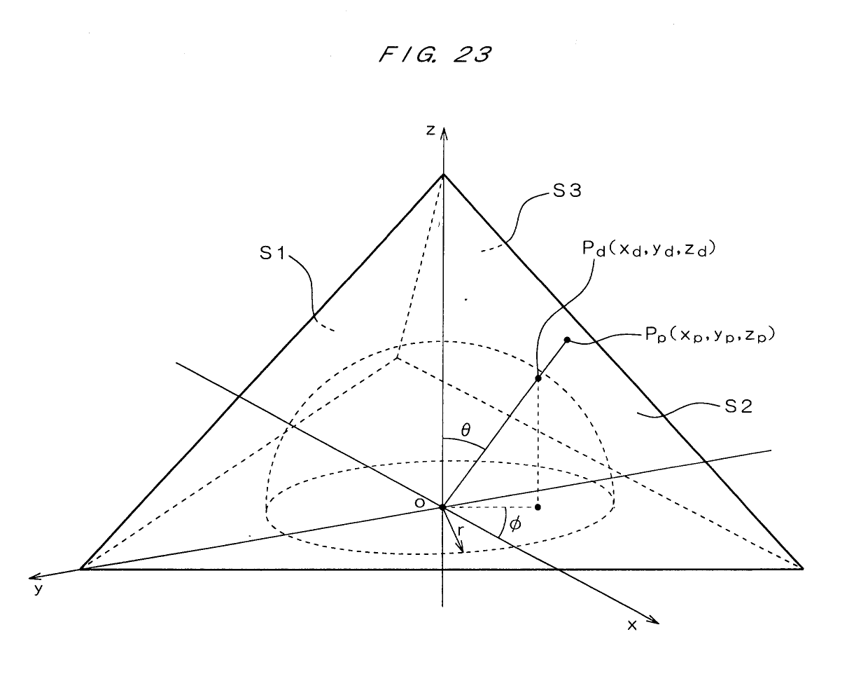

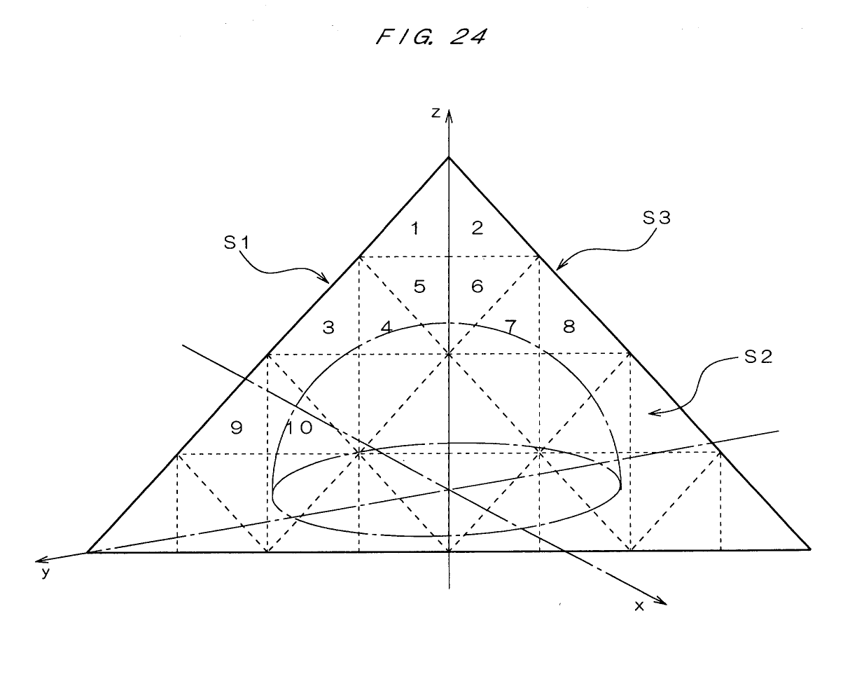

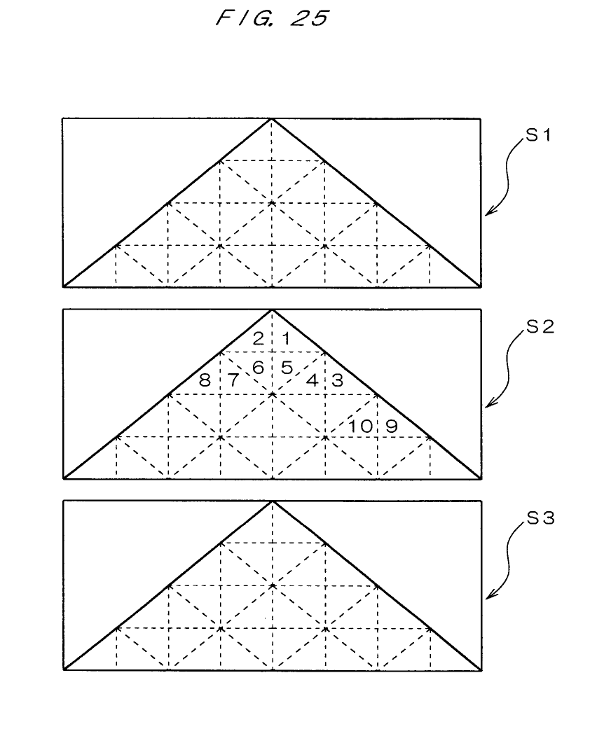

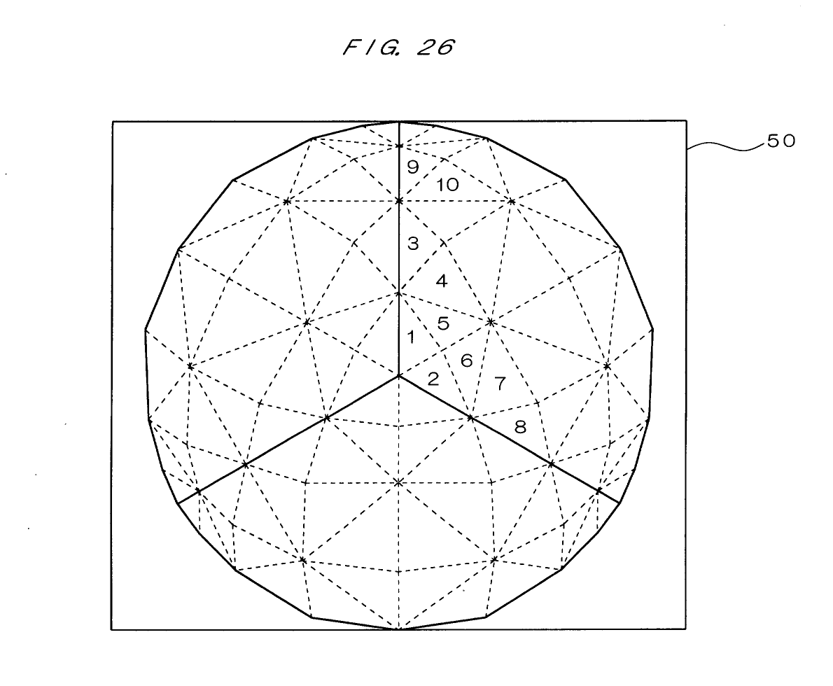

FIGS. 23 to 26 show other examples of the cases in which a 3-dimensional object is projected using three planes, and correspond to FIGS. 2, and 5 to 7. FIG. 23 shows three virtual planes S1, S2, and S3 used in the projecting process performed by the plane processing section 41. These three planes S1 through S3 correspond to the respective planes excluding the bottom plane of a trigonal pyramid, surround the sphere (or a similar sphere) containing the spherical screen 4, and adjacent planes are perpendicular to each other. The three planes S1 through S3 are right-angled isosceles triangular. FIG. 24 shows a practical example of a plurality of sectioned areas respectively corresponding to the three virtual planes S1 through S3. FIG. 25 shows the correspondence between the image information stored in the flat buffer 44 and the sectioned areas forming the three planes S1 through S3. FIG. 26 shows the correspondence between the circular frame buffer 50 and the respective sectioned areas of the three planes S1 through S3.

Thus, since even the three virtual planes S1 through S3 can cover the entire spherical screen 4 by using appropriate arrangements and shape of each plane, the forward periphery of the eyepoint can be covered by the planes, thereby transferring the image information corresponding to the 3-dimensional object in the direction of the view to the circular frame buffer 50.

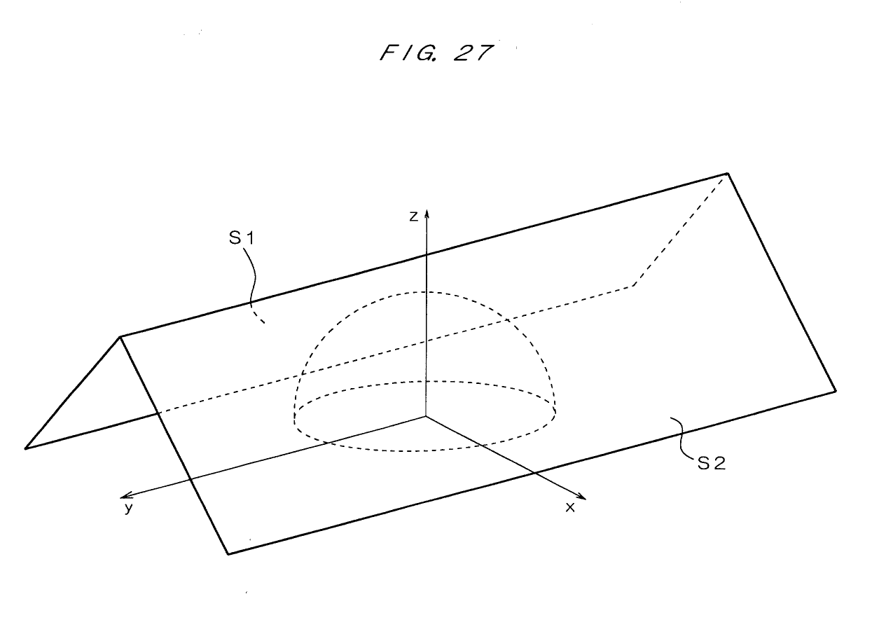

FIG. 27 shows a practical example of the case in which two planes are used in projecting an image of a 3-dimensional object. The two planes S1 and S2 shown in FIG. 27 are obtained by extending the two planes S1 and S2 shown in FIG. 15 in two directions (toward the planes S3 and S4 shown in FIG. 16). Thus, two planes S1 and S2 can project an image onto the substantially entire area of the spherical screen 4. Especially, by setting the number of a plurality of virtual planes to 2, the number of planes to be processed in the perspective projection conversion by the perspective projection converting section 42 can be further reduced, thereby considerably shortening the processing time required to perform the perspective projection conversion. In this case, there are two parts of the substantially circular polygonal area to which image information cannot be transferred. However, when there is a portion of the spherical screen 4 which is hard to come into the view of the player, when there can be the case in which an image is not to be projected onto a part of the spherical screen 4 for any reason, etc., an undesirable case in which a part of a projected image can be lost due to the two planes S1 and S2 as shown in FIG. 27 can be practically avoided.

As an extreme example, only one plane S5 shown in FIG. 2, or only one plane S5′ obtained by enlarging the area of the plane S5 can be used. In this case, an image cannot be projected onto the entire spherical screen 4, but an image with little distortion can be projected onto a part of the spherical screen 4. Especially, by setting the number of a plurality of virtual planes to 1, the number of planes to be processed in the perspective projection conversion by the perspective projection converting section 42 can be further reduced, thereby considerably shortening the processing time required to perform the perspective projection conversion.

1. An image display device which projects an image of a 3-dimensional object arranged in a virtual 3-dimensional space onto a curved surface screen through a wide-angle lens, comprising:
a frame buffer in which a position in which an image is to be projected onto a curved surface screen corresponds to a storage position of image information;
a projection device for emitting the image corresponding to the image information stored in said frame buffer to the wide-angle lens;
plane processing unit for performing a perspective projection conversion on a 3-dimensional object onto a plurality of virtual planes, and storing the image information corresponding to each plane in a flat buffer; and
image information transferring unit for reading the image information from the flat buffer for each of a plurality of sectioned areas forming the plurality of virtual planes, and storing the image information in a corresponding area of the frame buffer.

2. The image display device according to claim 1,
wherein the wide-angle lens is a fisheye lens.

3. The image display device according to claim 1,
wherein said sectioned areas are polygonal, and there is further provided corresponding coordinate setting unit for associating a first storage coordinate of the flat buffer with a second storage coordinate of the frame buffer for each vertex of the polygon; and
said image information transferring unit reads the image information about the sectioned areas specified by a plurality of first storage coordinates from the flat buffer, and stores the image information in a predetermined area of the frame buffer specified by a plurality of second storage coordinates corresponding to the respective first storage coordinates.

4. The image display device according to claim 3,
wherein said corresponding coordinate setting unit holds correspondence information indicating correspondence between the first storage coordinate and the second storage coordinate, and
said image information transferring unit reads and stores the image information according to the correspondence information held by said corresponding coordinate setting unit.

5. The image display device according to claim 1,
wherein the number of a plurality of virtual planes is 5.

6. The image display device according to claim 1,
wherein the number of a plurality of virtual planes is 3 or 4.

7. The image display device according to claim 1,
wherein the number of a plurality of virtual planes is 2.

8. The image display device according to claim 1,
wherein a predetermined eyepoint location is different from a projection position corresponding to a wide-angle lens.

9. The image display device according to claim 8,
wherein when the projection position is set to be different from a central position of the curved surface screen, the image information transferring unit amends brightness for the image information to be stored in the frame buffer with a distance between the projection position and the position in which an image is to be projected on the curved surface screen taken into account.

10. The image display device according to claim 1, further comprising: object computation unit for computing positional information about the virtual 3-dimensional space of the 3-dimensional object at predetermined time intervals,
wherein the process of storing the image information for the frame buffer is repeated at the time intervals.

11. An image displaying method, comprising:
a first step of performing a perspective projection conversion on a 3-dimensional object onto a plurality of virtual planes, and storing image information corresponding to each plane in a flat buffer;
a second step of reading the image information from the flat buffer for each of the plurality of sectioned areas forming the respective plural virtual planes, and storing the image information into the frame buffer of which the position in which an image to be projected on a curved surface screen corresponds to the storage position of the image information; and
a third step of reading the image information stored in the frame buffer and projecting the image information onto the curved surface screen through a wide-angle lens.

12. The image displaying method according to claim 11,
wherein said sectioned area is polygonal, and a first storage coordinate of the flat buffer is associated with a second storage coordinate of the frame buffer for each vertex of the polygon; and
in the second step, the image information about the sectioned area specified by a plurality of first storage coordinates is read from the flat buffer, and the image information is stored in a predetermined area of the frame buffer specified by a plurality of second storage coordinates corresponding to the respective first storage coordinates.

13. The image displaying method according to claim 12,
wherein the first storage coordinate of the flat buffer is associated with the second storage coordinate of the frame buffer with the predetermined eyepoint location and the projection position corresponding to the position of the wide-angle lens taken into account.

14. The image displaying method according to claim 13,
wherein when the projection position is different from the central position of the curved surface screen, the process in step 4 of amending the brightness of the image information stored to be in the frame buffer precedes the process in step 3 with the distance between the projection position and the position in which an image is to be projected onto the curved surface screen taken into account.

15. An information storage medium storing a program, comprising:
a first step of performing a perspective projection conversion on a 3-dimensional object onto a plurality of virtual planes, and storing image information corresponding to each plane in a flat buffer;
a second step of reading the image information from the flat buffer for each of the plurality of sectioned areas forming the respective plural virtual planes, and storing the image information into the frame buffer of which the position in which an image to be projected on a curved surface screen corresponds to the storage position of the image information; and
a third step of reading the image information stored in the frame buffer and projecting the image information onto the curved surface screen through a wide-angle lens.

16. The information storage medium according to claim 15,
wherein said sectioned area is polygonal, and a first storage coordinate of the flat buffer is associated with a second storage coordinate of the frame buffer for each vertex of the polygon, and
in the second step, the image information about the sectioned area specified by a plurality of first storage coordinates is read from the flat buffer, and the image information is stored in a predetermined area of the frame buffer specified by a plurality of second storage coordinates corresponding to the respective first storage coordinates.

17. The information storage medium according to claim 16,
wherein said first storage coordinate of the flat buffer is associated with the second storage coordinate of the frame buffer with the eyepoint location and the projection position corresponding to the position of the wide-angle lens taken into account.

18. The information storage medium according to claim 17,
wherein when the projection position is different from the central position of the curved surface screen, the process in step 4 of amending the brightness of the image information to be stored in the frame buffer precedes the process in step 3 with the distance between the projection position and the position in which an image is to be projected onto the curved surface screen taken into account.

19. An image display program used to direct a computer to project an image of a 3-dimensional object arranged in a virtual 3-dimensional space onto a curved surface screen through a wide-angle lens, comprising:
a first step of performing a perspective projection conversion on a 3-dimensional object onto a plurality of virtual planes, and storing image information corresponding to each plane in a flat buffer;
a second step of reading the image information from the flat buffer for each of the plurality of sectioned areas forming the respective plural virtual planes, and storing the image information into the frame buffer of which the position in which an image to be projected on a curved surface screen corresponds to the storage position of the image information; and
a third step of reading the image information stored in the frame buffer and projecting the image information onto the curved surface screen through a wide-angle lens.

20. The image display program according to claim 19,
wherein the sectioned area is polygonal, and a first storage coordinate of the flat buffer is associated with a second storage coordinate of the frame buffer for each vertex of the polygon, and
in the second step, the image information about the sectioned area specified by a plurality of first storage coordinates is read from the flat buffer, and the image information is stored in a predetermined area of the frame buffer specified by a plurality of second storage coordinates corresponding to the respective first storage coordinates.

21. The image display program according to claim 20,
wherein said first storage coordinate of the flat buffer is associated with the second storage coordinate of the frame buffer with the predetermined eyepoint location and the projection position corresponding to the position of the wide-angle lens taken into account.

22. The image display program according to claim 21,
wherein when the projection position is different from the central position of the curved surface screen, the process in step 4 of amending the brightness of the image information to be stored in the frame buffer precedes the process in step 3 with the distance between the projection position and the position in which an image is to be projected onto the curved surface screen taken into account.
